(19) United States
(12) Patent Application Publication
(10) Pub. No.: US 2012/0327786 A1
(43) Pub. Date: Dec. 27, 2012

(54) METHOD FOR MAPPING GENERIC CLIENT SIGNALS INTO A GENERIC FRAMING PROCEDURE (GFP) PATH

(75) Inventors: ILIAN SEVDALINOV TZVETANOV, Ottawa (CA); MICHAEL ANDREW VANDEGRIEND, Ottawa (CA)

(73) Assignee: EXAR CORPORATION, Fremont, CA (US)

(21) Appl. No.: 13/167,581

(22) Filed: Jun. 23, 2011

(51) Int. Cl. H04L 29/02; H04L 12/26

(52) U.S. Cl. 370/242; 370/474

(57) ABSTRACT

10 bit words from a client are packed into 64B/65B blocks such that at least some of the blocks have data containing only a portion of at least some of the 10 bit words. The 64B/65B blocks are combined into groups of eight to form superblocks. The superblocks are combined in multiples of five to form a Generic Framing Procedure (GFP) frame such that the GFP frame contains an integer number of complete 10 bit words with no partial 10-bit words.

### FIELD OF THE INVENTION

The present application relates to optical networking and in particular to methods of putting client data into a format for transmission using optical networks.

### BACKGROUND

Optical networking is a way to send large amounts of data across optical fiber. A number of protocols have been developed to transmit the optical signals.

As demand for high speed data becomes more desirable, optical switched networks, such as the optical transport network (OTN) and synchronous optical networking (SONET)/synchronous digital hierarchy (SDH) have become more popular.

One way to send client signals over a transport network is to use the Generic Framing Procedure (GFP).

Generic Framing Procedure (GFP) is a mapping technique defined by ITU-T G.7041. It allows mapping of variable length, higher-layer client signals over a circuit switched transport network like OTN or SDH/SONET.

There are two types of GFP frames: a GFP client frame and a GFP control frame. A GFP client frame can be further classified as either a client data frame or a client management frame. The former is used to transport client data, while the latter is used to transport point-to-point management information like loss of signal, etc. Client management frames can be differentiated from the client data frames based on the payload type indicator. The GFP control frame consists only of a core header field with no payload area. This frame is used to compensate for the gaps between the client signal where the transport medium has a higher capacity than the client signal, and is better known as an idle frame.

There are two modes of GFP: Generic Framing Procedure-Framed (GFP-F) and Generic Framing Procedure-Transparent (GFP-T):
GFP-F maps each client frame into a single GFP frame. GFP-F is used where the client signal is framed or packetized by the client protocol.
GFP-T, on the other hand, allows mapping of 8B/10B block-coded client data into an efficient 64B/65B block code for transport within a GFP frame. The transparent GFP specification only describes operation for 8B/10B encoded data. The 8B/10B data is converted into 8-bit words then packed into the 64B/65B blocks.

### SUMMARY

Generic Framing Procedure (GFP) is a standard communication protocol that specifies a mechanism for adapting traffic from client signals for transmission through a transport network. Certain types of client signals require low transmission latency and are transparently mapped into a GFP frame. This transparent GFP process is defined in the standard only for client signals encoded with the 8B/10B encoding scheme.

If the client signal needs to be transported transparently and is unknown or not encoded with 8B/10B, then new transparent mapping methods are needed. These new mapping methods require that a generic client signal can be mapped into a GFP path using the transparent GFP mapping scheme.

Embodiments of the present invention are methods of extending the operation of transparent GFP to deal with 8 or 10-bit words of any format. For example, 10-bit words could be encoded in an unknown 8B/10B code and rather than require that this 8B/10B code be decoded before placed into transparent GFP frames, the 10-bit words can be directly placed into the GFP frames.

10-bit words are packed into 64B/65B blocks such that at least some of the blocks contain only a portion of at least some of the 10-bit words. Portions of some of the 10-bit words are then mapped to different 64B/65B. The 64B/65B blocks are combined into groups of eight to form super blocks. The superblocks are put into GFP frames in multiples of five to ensure that the GFP frame contains an integer number of the 10-bit words and that the GFP frame does not contain any partial 10-bit words. 8-bit words can also be mapped to the 64B/65B blocks with eight 8-bit words in each 64B/65B block. Further, any client bit stream can be grouped into 8-bit words and then mapped into 64B/65B blocks.

In this way, the advantages of the transparent GFP mode can be provided for any type of 8 or 10-bit word data.

### BRIEF DESCRIPTION OF THE DRAWINGS

FIG. 1 shows the use of transmitter and receiver blocks that put a client 8 or 10 bit words into transparent GFP frames and back into 8 or 10-bit words.

FIG. 2 shows operations that are done on the 10-bit words to put them into GFP frames in one embodiment.

FIG. 3 shows the placing of 10-bit words into 64B/65B blocks such that data of one of the 10-bit words crosses the boundary of the 64B/65B blocks.

FIG. 4 shows the placing of 8-bit words into 64B/65B blocks.

### DETAILED DESCRIPTION

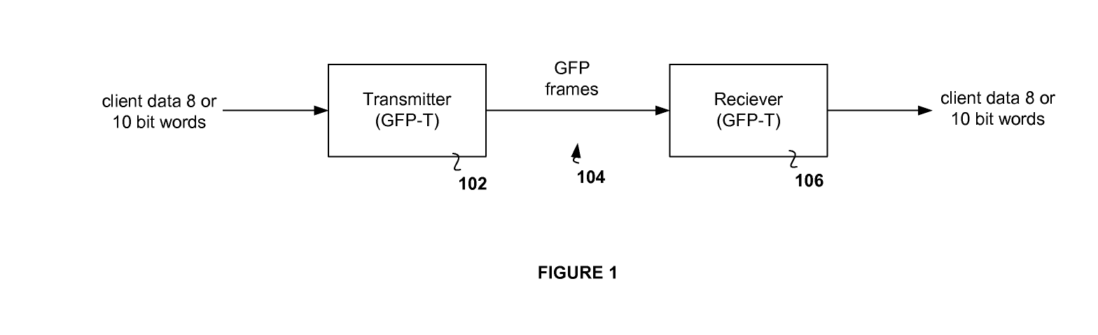

FIG. 1 shows a transmitter block 102 that puts client data in 8 or 10-bit words into transparent GFP frames. The receiver 106 can then recover the 8 or 10-bit words. The GFP frames can be sent on an optical network 104, a wired network, or a wireless network.

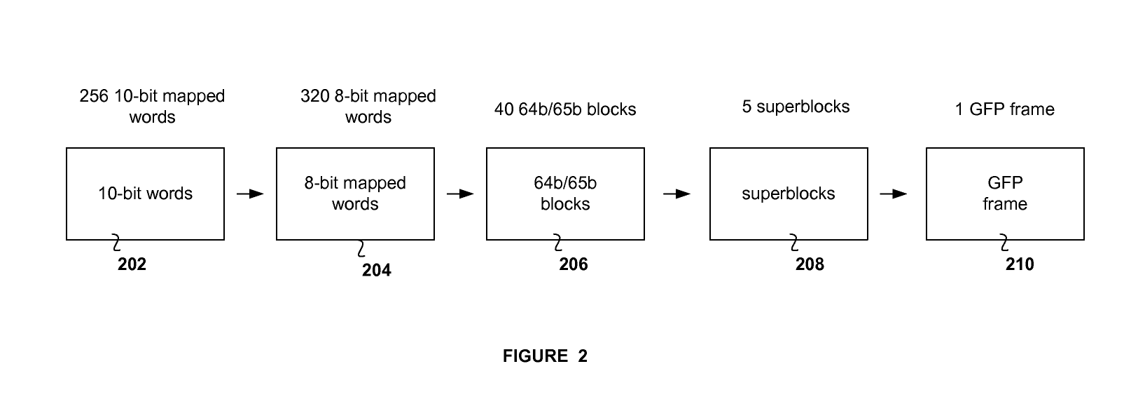

FIG. 2 shows the packing of the GFP frames with 10 bit words. 256 10-bit words 202 are mapped into 320 8-bit mapped words. This increases the number of words since this process is not an 8B/10B conversion, but a remapping of the 10-bit words into 8-bit words. The 8-bit mapped words are then placed into the 64B/65B blocks 206. 40 of the 64B/65B blocks are then combined to form 5 superblocks. The superblocks 208 are then placed a GFP frame. Using multiples of 5 superblocks in each GFP frame ensures that no partial 10-bit words are sent in a GFP frame. Different GFP frames can contain data from different sources.

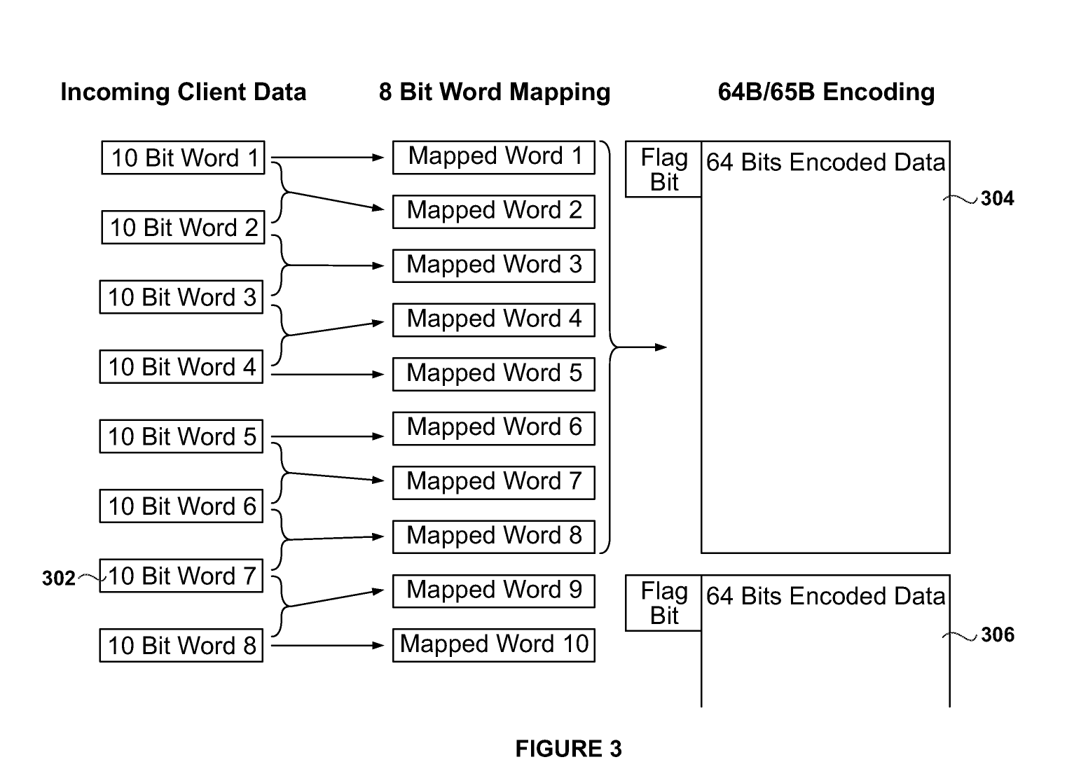

FIG. 3 shows the mapping of the 10-bit words into the 64B/65B blocks. The flag bit of the 64B/65B blocks can be set to indicate data. Note that data from at least one 10-bit word, in this case word 302, is mapped into two different 64B/65B blocks 304 and 306.

As described above, the use of multiples of 5 of the superblocks allows the 10-bit word data to be received and reconstructed at the receiver with no partial 10-bit words. This avoids the problems that could over wise occur with a dropped GFP frame or require the storing of partial frames until the next GFP frame.

The GFP frames are sent on an optical network. The GFP frames include a header and error correction codes. The GFP frames are sent in a transparent mode.

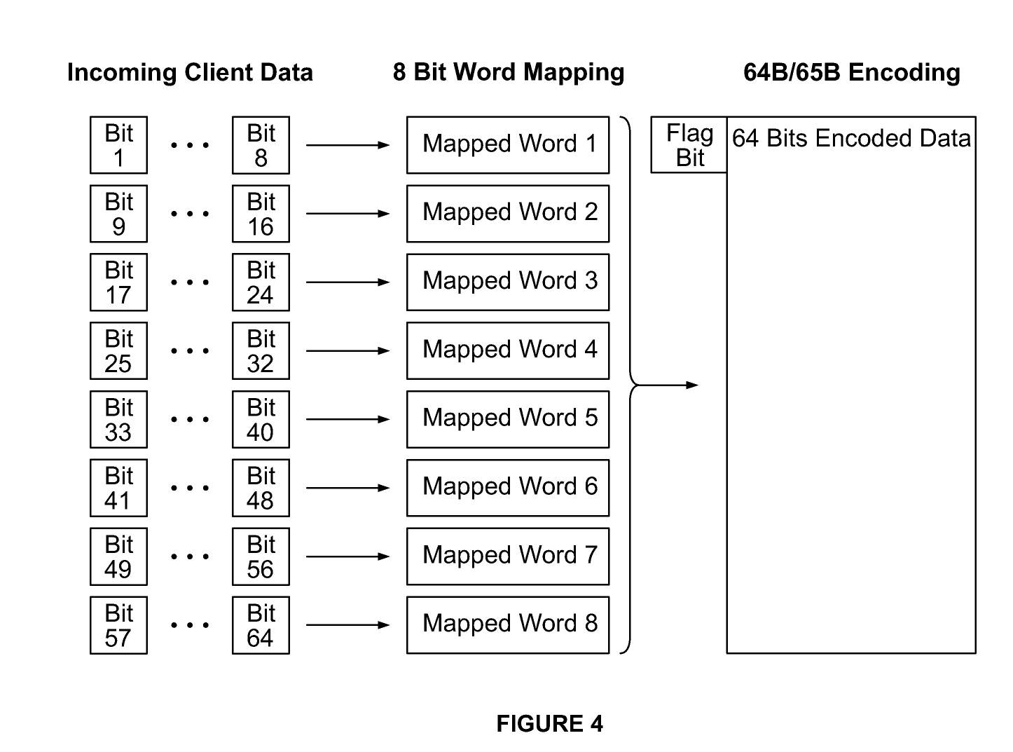

8-bit words can also be put into an 64B/65B blocks, as shown in FIG. 4. In this case, eight of the 8-bit words fit into each 64B/65B blocks. Further, any client bit stream can be grouped into 8-bit words then put into 64B/65B blocks.

One embodiment of the present invention is a method to receive 10-bit words from a client. The 10-bit words are packed into 64B/65B blocks such that at least some of the blocks have data containing only a portion of at least some of the 10-bit words as shown in FIG. 3. The 64B/65B blocks are combined into groups of eight to form superblocks. The superblocks are combined in multiples of five to form a Generic Framing Procedure (GFP) frame such that GFP frame contains an integer number of complete 10-bit words.

Mapping of non 8B/10B encoded client signals into transparent GFP can be divided into two schemes. The first scheme will take any client signal and split its stream of data into 8-bit words, referred to as generic 8-bit mapping. The second scheme, referred to as generic 10-bit mapping, rearranges the 10-bit works into 8-bit words.

The defined transparent GFP mapping of 8B/10B client signals is performed by first decoding the 8B/10B codewords into 8-bit data words or 8-bit control characters. A group of 8 decoded codewords are then encoded in a 64B/65B encoding in which a flag bit indicates if there are control characters present in the encoded data. The transparent mapping process then groups 8 blocks of 64B/65B encoded data into a superblock that can then be transmitted in a GFP frame.

In the case of the generic 8-bit mapping method, the incoming client data stream is sliced into 8-bit data words. The 8 data words are then 64B/65B encoded with the flag bit set to indicate only data words present in the encoded data and no control characters. The 64B/65B data is then grouped into superblocks and processed the same as 8B/10B based transparent GFP mapping.

In the case of generic 10-bit mapping method, the incoming client data stream is presented as 10 bits of data. These 10 bits are broken into 8-bit data words that are then 64B/65B encoded with the flag bit indicating only data words present in the encoded data and no control characters. The 64B/65B encoded data is then grouped in sets of 8 to form superblocks and processed the same as 8B/10B based transparent GFP mapping. If the alignment of the incoming 10-bit data words needs to be maintained on the egress of the GFP path, then the GFP frames must consist of 5 superblocks or a multiple of 5 superblocks. This requirement ensures that no partial 10-bit words are mapped into a GFP frame and thus a GFP frame will always begin with a full 10-bit data word. Should this requirement not be met and there is a dropped frame in the GFP path, then the 10-bit alignment would be lost and would be impossible to recover.

The mapping and demapping of generic client signals must handle the case of client signal fail (CSF). On the ingress to a GFP path, CSF is handled the same for both generic and known client signals. In this case, the GFP path sends idle control frames and client management frames indicating CSF. On the egress of the GFP path, the response to CSF for known client signals is specific to the client signal protocol. Likewise, a specific response to CSF is needed for generic signals. For generic 8-bit mapping, the GFP egress generates a bit pattern consisting of all ones. For generic 10-bit mapping, the GFP egress generates an unrecognized 10-bit neutral disparity codeword. In an exemplary embodiment, depending on the current running disparity on the egress 10-bit interface, this codeword is 0011110001 for negative disparity, or 1100001110 for positive disparity.

Clock recovery is necessary on the egress GFP path to reproduce the clock for the demapped client signal. The clock recovery mechanism may be implemented using a variety of methods.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A method comprising:
receiving 10-bit words from a client;
packing the 10-bit words into 64B/65B blocks such that at least some of the blocks have data containing only a portion of at least some of the 10-bit words;
combining at least some of the 64B/65B blocks in groups of eight to form superblocks;
combining superblocks in multiples of five to form a Generic Framing Procedure (GFP) frame such that GFP frame contains an integer number of the 10-bit words with no partial 10-bit words.

2. The method of claim 1, wherein the flag bit of the 64B/65B blocks is set to indicate data.

3. The method of claim 1, wherein the GFP frames are sent on an optical network.

4. The method of claim 1, wherein the GFP frames include a header.

5. The method of claim 1, wherein the GFP frames include error correction codes.

6. The method of claim 1, wherein the GFP frames are sent in a transparent GFP mode.

7. The method of claim 1, wherein the 10-bit words are remapped as a larger number of 8-bit words before being put into 64B/65B blocks.

8. The method of claim 1, wherein upon ingress to the GFP path, a client signal fail is indicated by sending idle control frames and client management frames indicating client signal fail.

9. The method of claim 1, wherein, for generic 10-bit mapping, upon egress to the GFP path, a client signal fail is indicated by an unrecognized 10-bit neutral disparity codeword.

10. An apparatus adapted to:
receive 10 bit words from a client;
pack the 10 bit words into 64B/65B blocks such that at least some of the blocks have data containing only a portion of at least some of the 10 bit words;
combine 64B/65B blocks in groups of eight to form superblocks;
combine superblocks in multiples of five to form a Generic Framing Procedure (GFP) frame such that GFP frame contains an integer number of the 10 bit words with no partial 10-bit words.

11. The apparatus of claim 10, wherein the flag bit of the 64B/65B blocks is set to indicate data.

12. The apparatus of claim 10, wherein the GFP frames are sent on an optical network.

13. The apparatus of claim 10, wherein the GFP frames include a header.

14. The apparatus of claim 10, wherein the GFP frames include error correction codes.

15. The apparatus of claim 10, wherein the GFP sends the frames are sent in a transparent GFP mode.

16. The apparatus of claim 10, wherein the 10-bit words are remapped as a larger number of 8-bit words before being put into 64B/65B blocks.

17. The apparatus of claim 10, wherein upon ingress to the GFP path, a client signal fail is indicated by sending idle control frames and client management frames indicating client signal fail.

18. The apparatus of claim 10, wherein, for generic 10-bit mapping, upon egress to the GFP path, a client signal fail is indicated by an unrecognized 10-bit neutral disparity codeword.

19. A method comprising:
receiving a client bit stream;
grouping the bit stream into 8-bit words
putting into the 8-bit words into 64B/65B blocks;
combining at least some of the 64B/65B blocks in groups of eight to form superblocks; and
using at least one superblock to form a Generic Framing Procedure (GFP) frame.

20. The method of claim 19, wherein the flag bit of the 64B/65B blocks is set to indicate data.

21. The method of claim 19, wherein the GFP frames are sent on an optical network.

22. The method of claim 19, wherein the GFP frames include a header.

23. The method of claim 19, wherein the GFP frames include error correction codes.

24. The method of claim 19, wherein the GFP frames are sent in a transparent GFP mode.

25. The method of claim 19, wherein upon ingress to the GFP path, a client signal fail is indicated by sending idle control frames and client management frames indicating client signal fail.

26. The method of claim 19, wherein, for generic 8-bit mapping, upon egress to the GFP path, a client signal fail is indicated by a bit pattern consisting of all ones.
